(19) United States
(12) Patent Application Publication
(10) Pub. No.: US 2006/0192168 A1
(43) Pub. Date: Aug. 31, 2006

(54) Suction actuated gravity deactivated ball valve

(76) Inventor: Bruce A. Thompson, Granite Bay, CA (US)

Correspondence Address: Dr. Bruce A. Thompson, 6700 Auburn Folsom Road, Granite Bay, CA, 95746, US

(21) Appl. No.: 11/354,320

(22) Filed: Feb. 13, 2006

Related U.S. Application Data
(60) Provisional application No. 60/653,635, filed on Feb. 17, 2005.

(51) Int. Cl. F16K 1/00

(52) U.S. Cl. 251/318; 251/333

(57) ABSTRACT

The present invention describes a ball valve that opens when suction is applied at the top of the ball and closes once the suction is removed. The activation force is created by suction and the deactivation force is gravity. Advantageously, the ball slides on a guide post that ensures that the ball falls into the proper orientation in the valve seat. The top of the guide post has a limit stopper that prevents the ball from opening too far.

This non-provisional utility patent application claims filing priority of provisional application No. 60/653,635 filed Feb. 17, 2005.

### BRIEF DESCRIPTION

The subject of this invention relates to valve technology. More specifically, the disclosed invention describes a ball valve that is operated by suction and is suitable for applications such as cleaning of large particulates from ponds, pools, aquariums and the like. Unlike prior art valves, the disclosed invention requires no springs or hinges. Upon the removal of suction from the top of the ball, gravity causes the ball to return to the seat thereby closing the valve.

### BACKGROUND OF THE INVENTION

Ball valves have been in use for many years. Applications include toilet stoppers, high pressure water jets, and push operated float valves. Each of these works well in its given application. However, when large particulates are to be scavenged from the bottom of a vessel, for example, a fountain or pool, each of the prior art valve mechanisms suffer from one or more limitations. For example, a float valve would work to open when placed in the pool, but would not close before particulates that had been removed fall out.

A hinged valve such as a toilet stopper would suffer from the same problem to a lesser degree. Nonetheless, some of the particulates that entered under the influence of a suction force, for example, from a hose or pump, would fall out as the valve pivoted on its hinge. This is so because the valve will have a comparatively wide opening on one side and a comparatively small opening on the other due to the pivot point provided by the hinge.

Spring loaded valves suffer from a number of problems as well. For example, the simple suction force provided by a hose or pump is unlikely to overcome the closure force applied by the spring. While solenoid operated valves could be used, they would require a power source and added complexity increasing cost and reducing reliability.

What would be desirable would be a valve that opened under the influence of a comparatively small suction force, remained open until the suction force was removed, and then close of its own volition. Further, it would be desirable that the valve have a uniform opening around its perimeter sufficiently large to allow particulates to enter yet small enough to prevent trapped particulates from escaping once the suction force was removed. The present invention provides these and other advantages as discussed in detail below.

### SUMMARY OF THE INVENTION

The present invention describes a ball valve that opens when suction is applied at the top of the ball and closes once the suction is removed. The activation force is created by suction and the deactivation force is gravity. Advantageously, the ball slides on a guide post that ensures that the ball falls into the proper orientation in the valve seat. The top of the guide post has a limit stopper that prevents the ball from opening too far.

The valve of the present invention is comprised of a seat, a guide post and a ball. The seat is cylindrical and may be threaded on the outer surface to allow easy mounting to a chamber such as that used to trap particulates in a pool cleaner. The guide post consists of a shaft which is threaded on the lower end and has a limit stop on the upper end. The ball is dimensioned to fit accurately on the inner surface of the seat. The ball has a hole through the center that allows the shaft of the guide post to easily slide through. When assembled, the guide post passes through the ball and threads into the base of the seat.

In operation, the valve assembly is immersed in a vessel containing particulates that need to be removed. Since the ball is fabricated from a material that does not float, gravity keeps the ball sealed in the seat. When a suction force is applied to the top of the ball, for example, by a hose or pump, the ball rides up the guide post allowing any particulates proximate to the suction flow to be swept into a chamber and trapped. Once the suction force is removed gravity causes the ball to return to its initial location in the seat before any suspended particulates may escape.

The valve mechanism of the present invention offers several advantages over the prior art. Among these are multiple uses, ease of operation and economical construction. As well as these advantages, the present invention has other advantages discussed in detail below in conjunction with the drawings and figures attached.

### BRIEF DESCRIPTION OF THE DRAWINGS

FIG. 1: is an exploded view of one embodiment of the present invention.

FIG. 2A: provides a cross sectional view of the details of one embodiment of the present invention.

FIG. 2B: provides a top view of the seat details of one embodiment of the present invention.

FIG. 3: shows one embodiment of the present invention in the closed state.

FIG. 4: shows one embodiment of the present invention in the open state.

### DETAILED DESCRIPTION OF PREFERRED EMBODIMENTS

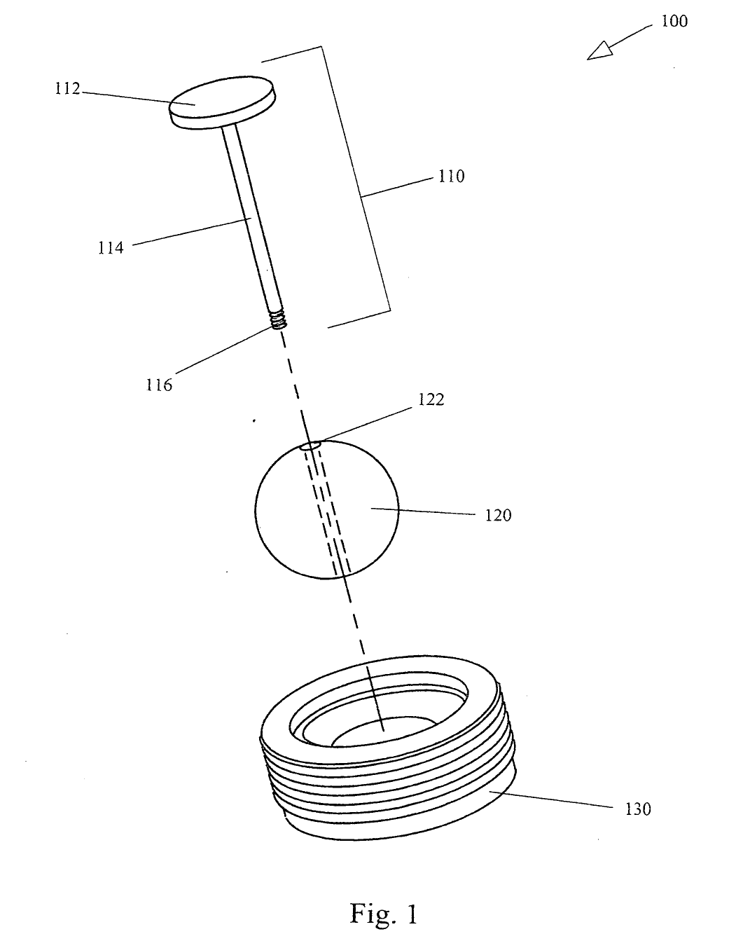

As described briefly above, the valve of the present invention is comprised of three parts: a seat, a guide post and a ball. FIG. 1 shows an exploded view of one embodiment 100 of the present invention. The guide post 110 has a shaft 114 and a limit stop 112. Threads 116 at the bottom of the guide post 110 are used to attach the guide post 110 the seat 130.

The ball 120 has a hole 122 passing through the center of the sphere. The hole 122 is small enough so that the shaft 114 easily passes but not so large that the ball 120 wobbles. The purpose of the hole 122 is to allow the ball 120 to move upward and downward along the shaft 114 without binding. When, as described in detail below, a suction force is applied, the ball 120 is free to move upward in response. Shaft 114 prevents the ball 120 from traveling too far upward as well as preventing any lateral displacement as a result of the turbulence caused by the suction force.

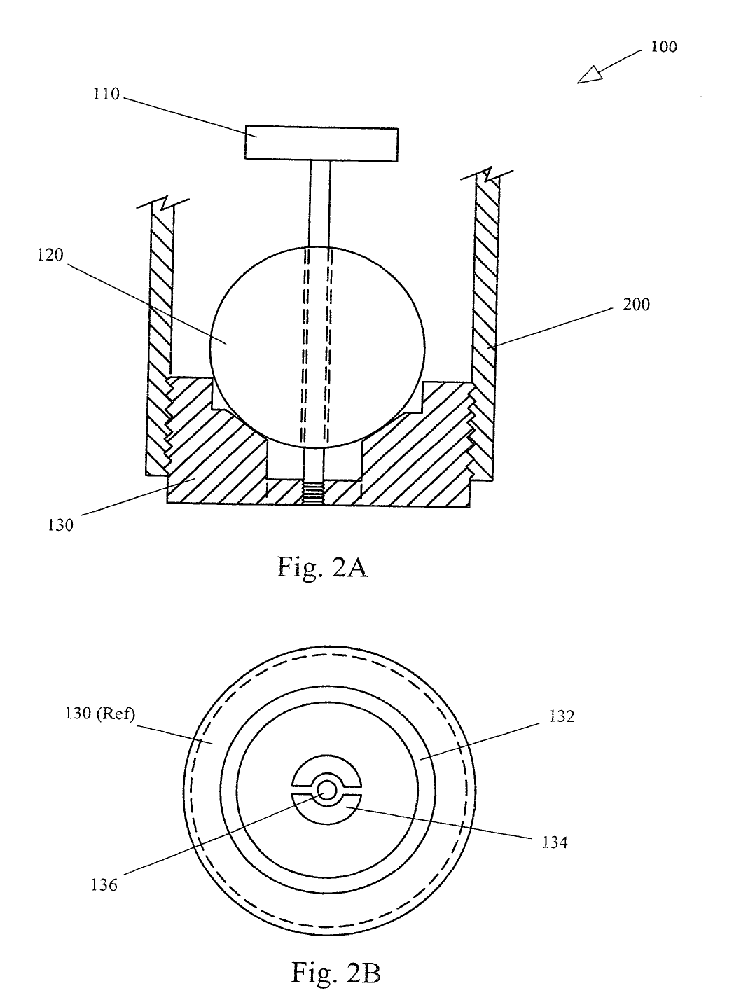

Referring to FIG. 2A, the embodiment 100 of FIG. 1 is shown assembled in cross section. The ball 120 is resting in the seat 130 thus the valve is in the closed, or deactivated position. The shaft of the guide post 110 ensures that the ball 120 locates properly in the seat 130. Also shown in FIG. 2A is housing 200. For this embodiment seat 130 threads into the bottom of housing 200 however, it will be recognized that this is not the only configuration that can make use of the ball valve of the present invention thus this should not be read as a limitation on the scope of the invention.

FIG. 2B presents a top view of the seat 130. As shown, the seat 130 is further comprised of a ball seal 132, a threaded receiving hole 136 and two openings 134. The receiving hole 136 is attached to the body of the seat 130 by means of two spokes. This allows the open areas 134 to pass particulates under the influence of a suction force. The size of the seat 130 and the openings 134 can be varied to allow for larger or smaller particulates, thus the particular ratio of opening to seat area in FIG. 2B should not be read as a limitation on the scope of the invention.

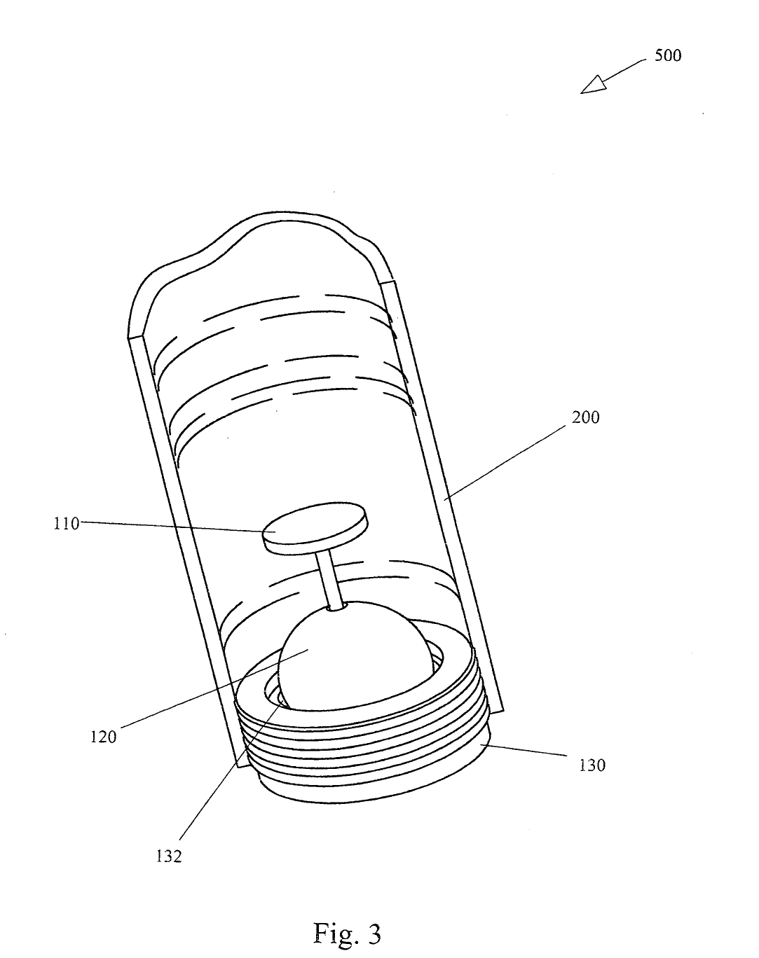

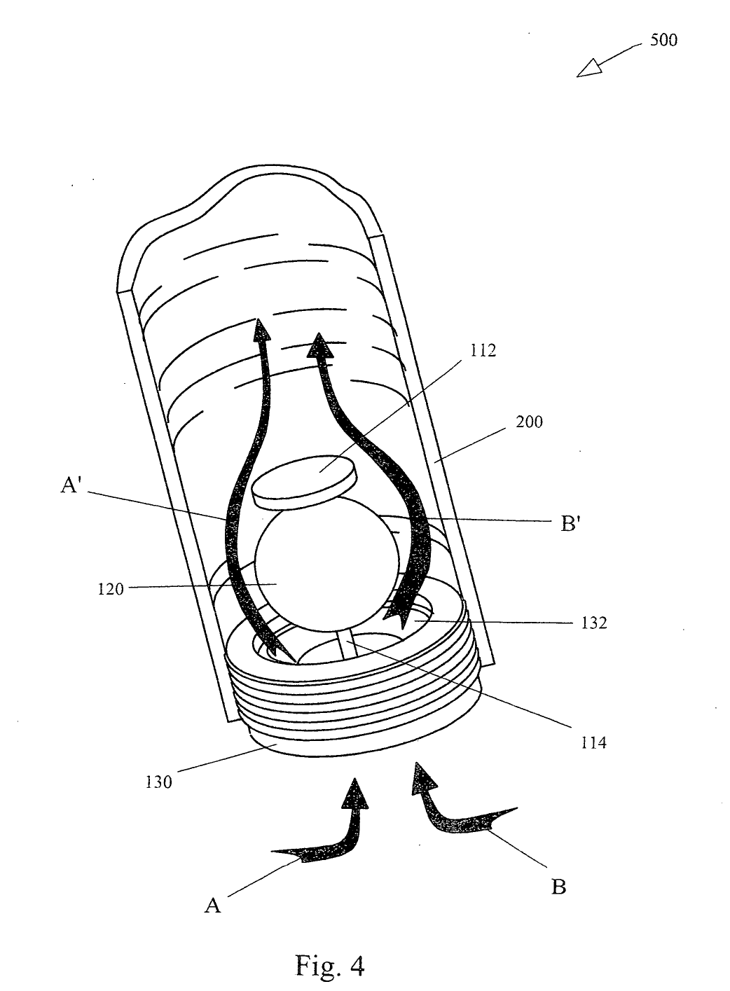

FIGS. 3 and 4 together describe the operation of the ball valve of the present invention. Beginning with FIG. 3, the valve assembly 500 is shown in the closed or deactivated position. For this embodiment the seat 130 has been threaded into a housing 200. Not shown, but part of the housing is a particulate trap mechanism. Also not shown is a wand and suction generating mechanism used to create the suction force necessary to operate the valve of the present invention. Since these mechanisms do not contribute to the operation of the present invention they are not shown for clarity.

In FIG. 3 the ball 120 has been guided to rest in the seal of the seat 130 by the guide post 110. This occurs due to gravity as a user submerges the housing 200 in a vessel to be cleaned. Since the ball 120 is made of a material that sinks in water, for example PVC [polyvinyl chloride,] as a user orients the wand downward to immerse the ball valve housing 200, the ball 120 drops down the shaft (114 of FIG. 1) to the seal 132. Proper location of the ball 120 on the seal 132 is ensured by guide post 110. At this time any particulates trapped in the housing 200 are unable to escape due to the ball valve closure.

Turning now to FIG. 4, the valve assembly 500 of the present invention is shown in the activated or open state. A suction force has been applied at the top of the housing 200 causing inward flows A and B from the bottom. There is a resultant force combined of the upward flows A and B and the suction force which causes the ball 120 to rise along the shaft 114 of the guide post. If left unchecked the ball would continue to rise but the guide shaft has a limit stop 112 that prevents this from happening.

With the ball disposed upwards, the inward flows A and B move past the ball 120, as shown by resultant flows A′ and B′. Any particulate that is in close proximity to the opening of the seat 130 will be swept upward with the flow, entering the housing 200 and becoming trapped when the suction force is removed. This occurs because, as the suction force is removed, the ball 120 slides downward along the shaft 114 of the guide post 110 and reseats in the seal 132.

One advantage of the present invention is that the ball always seats properly on the seal. Since this is accomplished using gravity, no springs or hinges are required making the present invention simple and therefore economical.

A second advantage of the present invention is that it may be used in a plurality of applications. Any application that can make use of a valve that opens under suction and closes by gravity may make use of the invention. Of course the size, material and required suction may differ from application to application, however the principle of the invention remains the same.

A third advantage of the present invention is that it is economical to construct. A preferred embodiment makes use of ABS plastics, but the valve could be constructed out of a number of materials in toto or in any combination.

A fourth advantage of the present invention is its simplicity. The entire valve has only three parts. This simplicity makes the valve of the present invention easy to fabricate and repair, adding to its economic advantage.

I claim:

1. A suction activated gravity deactivated ball valve comprising:
a valve seat, said valve seat having a female thread in its center;
a ball guide post, said guide post having a limit stop at one end and a male thread at the other end, and;
a ball wherein said ball has a hole through its central axis such that said threaded end of said guide post passes freely through said hole in said ball and threadably attaches to said female thread in said center of said seat, whereupon application of a suction force at the limit stop end of said guide post causes said ball to travel toward said limit stop and upon loss of said applied suction force said ball drops into said seat by force of gravity.

2. The valve of claim 1 wherein all parts of the valve are made from ABS plastic.

3. The valve of claim 1 suitable sized for use in cleaning particulates from small ponds, fountains or spas.
